(19) United States
(12) Patent Application Publication
(10) Pub. No.: US 2026/0029844 A1
(43) Pub. Date: Jan. 29, 2026

(54) METHOD FOR CONTROLLING SENSING APPARATUS, ELECTRONIC DEVICE, AND STORAGE MEDIUM

(71) Applicant: Beijing Zitiao Network Technology Co., Ltd., Beijing (CN)

(72) Inventor: Chuanxin GUO, Beijing (CN)

(21) Appl. No.: 19/284,019

(22) Filed: Jul. 29, 2025

(30) Foreign Application Priority Data
Jul. 29, 2024 (CN) 202411027181.7

(51) Int. Cl. G06F 3/01; G01B 11/22; G01S 7/4865; G01S 7/4915; G01S 17/894

(52) U.S. Cl. CPC G06F 3/013; G01B 11/22; G01S 7/4865; G01S 7/4915; G01S 17/894

(57) ABSTRACT

A method for controlling a sensing apparatus, an electronic device, and a storage medium are provided. The method includes: capturing image data of a real environment; displaying an extended reality image generated based on the image data; determining a gaze area of a user on the extended reality image; and adjusting a control parameter of a depth sensing apparatus based on the gaze area, where the control parameter includes at least one of a modulation frequency, exposure time, a frame rate, or a frame-rate proportion.

### CROSS-REFERENCE TO RELATED APPLICATION

This application claims the priority to and benefits of the Chinese Patent Application, No. 202411027181.7, which was filed on Jul. 29, 2024, and is hereby incorporated by reference in its entirety.

### TECHNICAL FIELD

The present disclosure relates to a field of computer technology, and in particular to a method for controlling a sensing apparatus, an electronic device, and a storage medium.

### BACKGROUND

Extended Reality (XR) technology is an umbrella term for Augmented Reality (AR), Virtual Reality (VR), and Mixed Reality (MR), which aims to combine the physical world with the virtual to provide the user with a three-dimensional scene that enables human-computer interaction. In the related extended reality devices, an eye-tracking apparatus and a sensing apparatus such as an RGB camera and a depth sensor are independent of each other. The control strategies of these sensing apparatuses are relatively single and are difficult to be adjusted in real time according to the specific needs of users or environmental changes, which limits the adaptability and flexibility of the sensing apparatuses in different application scenes.

### SUMMARY

The section of Summary is provided to present conceptions in brief form, and the conceptions will be described in detail in the section of Detailed Description that follows. The section of Summary is not intended to identify key features or essential features of the technical solutions for which protection is claimed, nor is it intended to limit the scope of the technical solutions for which protection is claimed.

According to one or more embodiments of the present disclosure, a method for controlling a sensing apparatus is provided, which includes:
capturing image data of a real environment;
displaying an extended reality image generated based on the image data;
determining a gaze area of a user on the extended reality image; and
adjusting a control parameter of a depth sensing apparatus based on the gaze area, where the control parameter includes at least one of a modulation frequency, exposure time, a frame rate, or a frame-rate proportion.

According to one or more embodiments of the present disclosure, an apparatus for controlling a sensing apparatus is provided, which includes:
an image capturing unit configured to capture image data of a real environment;
an image display unit configured to display an extended reality image generated based on the image data;
a gaze determination unit configured to determine a gaze area of a user on the extended reality image; and
a parameter adjustment unit configured to adjust a control parameter of a depth sensing apparatus based on the gaze area, where the control parameter includes at least one of a modulation frequency, exposure time, a frame rate, or a frame-rate proportion.

According to one or more embodiments of the present disclosure, an electronic device is provided, which includes: at least one memory and at least one processor; where the memory is configured to store program codes, and the processor is configured to execute the program codes stored in the memory to cause the electronic device to perform the method for controlling a sensing apparatus according to one or more embodiments of the present disclosure.

According to one or more embodiments of the present disclosure, a non-transitory computer storage medium is provided, the non-transitory computer storage medium storing program code, and the program code, upon being executed by a computer device, causing the computer device to perform the method for controlling a sensing apparatus according to one or more embodiments of the present disclosure.

### BRIEF DESCRIPTION OF DRAWINGS

The above and other features, advantages, and aspects of the embodiments of the present disclosure will become more apparent with reference to the drawings and the following specific implementations. Throughout the drawings, identical reference numerals represent identical elements. It should be understood that the drawings are schematic and that originals and elements are not necessarily drawn to scale.

FIG. 1 is a schematic flowchart of a method for controlling a sensing apparatus according to an embodiment of the present disclosure;

FIG. 2 is an optional schematic diagram of a virtual field of view of an extended reality device according to an embodiment of the present disclosure;

FIG. 3 is a schematic flowchart of a method for controlling a sensing apparatus according to another embodiment of the present disclosure;

FIG. 4 is a schematic flowchart of a method for controlling a sensing apparatus according to yet another embodiment of the present disclosure;

FIG. 5 is a schematic diagram of a system architecture according to yet another embodiment of the present disclosure;

FIG. 6 is a schematic structural diagram of an apparatus for controlling a sensing apparatus according to an embodiment of the present disclosure; and

FIG. 7 is a schematic structural diagram of an electronic device according to an embodiment of the present disclosure.

### DETAILED DESCRIPTION

Embodiments of the present disclosure will be described in more detail below with reference to the drawings. Although some embodiments of the present disclosure are shown in the drawings, it should be understood, however, that the present disclosure may be implemented in various forms and should not be construed as being limited to the embodiments set forth herein, but rather are provided for a more thorough and complete understanding of the present disclosure. It should be understood that the drawings and embodiments of the present disclosure are for exemplary purposes only and are not intended to limit the scope of protection of the present disclosure.

It should be understood that the various steps described in the method embodiments of the present disclosure may be performed in a different order, and/or in parallel. In addition, the method embodiments may include additional steps and/or omit performing the illustrated steps. The scope of the present disclosure is not limited in this regard.

The term “include” and its variants as used herein mean open-ended inclusion, i.e., “including but not limited to”. The term “based on” is “based at least in part on”. The term “one embodiment” means “at least one embodiment”; the term “another embodiment” means “at least one additional embodiment”; and the term “some embodiments” means “at least some embodiments”. The term “in response to” and related terms means that a signal or event is affected by another signal or event to some extent, but not necessarily fully or directly affected. If event x occurs “in response” to event y, then x may respond to y directly or indirectly. For example, the occurrence of y may eventually lead to the occurrence of x, but there may be other intermediate events and/or conditions. In other cases, y may not necessarily lead to the occurrence of x, and x may occur even if y has not yet occurred. In addition, the term “in response to” may also mean “at least partially in response to”.

The term “determine” broadly encompasses a wide variety of actions, which may include obtaining, calculating, computing, processing, deducing, researching, searching (e.g., searching in a table, database, or other data structure), proving, and the like, and may further include receiving (e.g., receiving information), accessing (e.g., accessing data in a memory), and the like, as well as parsing, selecting, and choosing, building, and the like. Relevant definitions of other terms will be given in the description below.

It should be noted that the concepts of “first”, “second” and the like mentioned in the present disclosure are only used to differentiate different apparatuses, modules or units, and are not used to limit the order or interdependent relationships of functions performed by these apparatuses, modules or units.

It should be noted that the modifications of “one” and “a plurality of” mentioned in the present disclosure are schematic rather than limiting, and persons skilled in the art should understand that, unless otherwise expressly stated in the context, they should be understood as “one or more”.

For the purpose of the present disclosure, the phrases “A and/or B” mean (A), (B), or (A and B).

In the following description, the names of messages or information interacted between a plurality of apparatuses in the embodiments of the present disclosure are used for illustrative purposes only and are not intended to limit the scope of those messages or information.

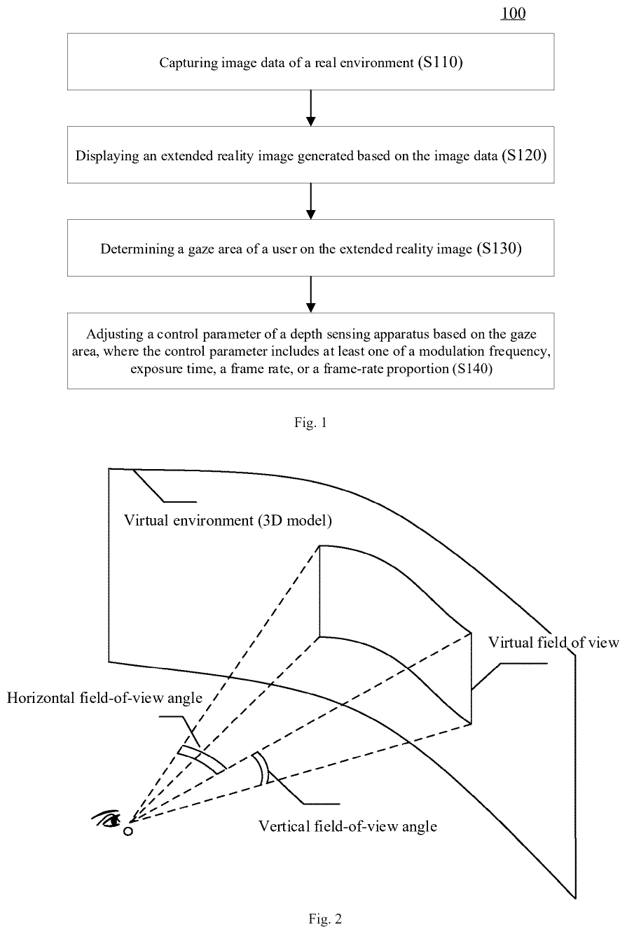

Reference is made to FIG. 1, which shows a schematic flowchart of a method 100 for controlling a sensing apparatus according to an embodiment of the present disclosure. The method 100 includes S110 to S140:
S110: capturing image data of a real environment.
S120: displaying an extended reality image generated based on the image data.
S130: determining a gaze area of a user on the extended reality image.
S140: adjusting a control parameter of a depth sensing apparatus based on the gaze area, where the control parameter includes at least one of a modulation frequency, exposure time, a frame rate, or a frame-rate proportion.

In some embodiments, the method 100 is performed at an electronic device (e.g., an extended reality device) that may be in communication with a display generation component (e.g., a display) and one or more sensing apparatuses (e.g., a head tracking apparatus, an eye-tracking apparatus, a hand tracking apparatus, a camera, or other sensing apparatuses). In some embodiments, the display generation component and the sensing apparatus may be integrated on the electronic device.

The extended reality device described in the embodiments of the present disclosure may include, but is not limited to, the following types:
a computer-based extended reality device that utilizes a PC terminal to perform calculations related to extended reality functions as well as data output, where the external computer-based extended reality device utilizes the data output from the PC terminal to achieve extended reality effects;
a mobile extended reality device that supports setting a mobile terminal (e.g., a smartphone) in various ways (e.g., a head-mounted display with a specialized card slot), where the mobile extended reality device is connected to the mobile terminal in a wired or wireless way, and the mobile terminal carries out calculations related to the extended reality functions and outputs data to the mobile extended reality device, e.g., the user watches an extended reality video through an APP of the mobile terminal; and
an all-in-one extended reality device that has a processor for carrying out the calculations related to the extended reality functions, and thus it has independent extended reality input and output functions, does not need to be connected to the PC terminal or the mobile terminal, and accordingly has a high degree of freedom in use.

The form of the extended reality device is not limited to this, and may be further miniaturized or enlarged according to needs.

In some embodiments, images of the real environment may be captured by an image sensing apparatus such as a camera, a video camera (e.g., an RGB video camera), a Bayer sensor, and the like. In some embodiments, the image sensing apparatus may capture image data (e.g., a video stream) of the real environment around it and performs preprocessing (e.g., including image stabilization, distortion correction, denoising, and brightness adjustment), then generates an extended reality image (e.g., an extended reality video stream) based on the processed image of the real environment and virtual content (if any), and displays the extended reality image on a screen of the electronic device in real time.

In some embodiments, the extended reality image may present a simulated environment of the physical world, a semi-simulated and semi-fictional virtual scene, or a purely fictional virtual scene, and the present disclosure is not limited thereto. The virtual scene may be any one of a 2D virtual scene, a 2.5D virtual scene, or a 3D virtual scene. The embodiments of the present disclosure do not limit the dimension of the virtual scene. For example, the virtual scene may include a sky, a land, an ocean, etc., and the land may include environmental elements such as a desert and a city. The user may control a virtual object to move in the virtual scene.

FIG. 2 shows an optional schematic diagram of a virtual field of view of an extended reality device according to an embodiment of the present disclosure, in which a distribution range of the virtual field of view in a virtual environment is described in a horizontal field-of-view angle and a vertical field-of-view angle, the distribution range in a vertical direction is denoted with the vertical field-of-view angle BOC, and the distribution range in a horizontal direction is denoted with the horizontal field-of-view angle AOB. Because the human eye is always able to perceive an image in the virtual environment through a lens, it can be understood that the larger the field-of-view angle is, the larger the size of the virtual field of view is, and the larger the area of the virtual environment that the user is able to perceive is. The field-of-view angle indicates the distribution range of a viewing angle that is available when an environment is perceived through the lens. For example, the field-of-view angle of the extended reality device indicates the distribution range of the viewing angle that the human eye has when the virtual environment is perceived through the lens of the extended reality device. For another example, for a mobile terminal provided with a camera, the field-of-view angle of the camera is the distribution range of the viewing angle that the camera has when the camera perceives the physical environment and takes pictures.

In some embodiments, the gaze area of the user may be determined through eye-tracking technology. For example, a user's eye image may be captured by one or more camera apparatuses (e.g., eye-tracking apparatuses) integrated on an electronic device (e.g., a head-mounted display device), human eye feature information (e.g., pupil information and corneal reflection information) may be extracted from the eye image, a gazing direction of the user is estimated based on the information, and the estimated gazing direction is then mapped to the display device (i.e., the electronic device) in front of the user to determine the specific area where the user is gazing. It should be noted that other eye-tracking technologies may be adopted to determine the gaze area of the user, and the present disclosure is not limited thereto.

In some embodiments, the extended reality device is integrated with a gaze tracking device, by which visual information of the user, such as the line of sight and the gaze point of the user may be acquired. In one embodiment, the gaze tracking device includes at least one eye-tracking camera (e.g., an infrared (IR) or near-infrared (NIR) camera), and an illumination source (e.g., an infrared or near-infrared light source, such as an array or ring of LEDs) that emits light (e.g., infrared or near-infrared light) toward the user's eye. The eye-tracking camera may point to the user's eye to receive infrared or near-infrared light of a light source that is reflected directly from the eye, or optionally may point to “hot” mirrors located between the user's eye and a display panel, where these hot mirrors reflect the infrared or near-infrared light from the eye to the eye-tracking camera and allow visible light to pass through. The gaze tracking device optionally captures images of the user's eye (e.g., as a video stream captured at 60 to 120 frames per second (fps)), analyzes these images to generate gaze tracking information, and transmits the gaze tracking information to the extended reality device. In some implementations, user's two eyes are tracked individually by the corresponding eye-tracking cameras and illumination sources. In some embodiments, only one of the user's eyes is tracked by the corresponding eye-tracking camera and illumination source.

In some embodiments, the depth sensing apparatus may include a depth sensor. The depth sensor is a device configured to measure the distance between an object and the sensor itself, and is capable of generating a depth map or point cloud data to construct three-dimensional spatial information. The type of the depth sensor includes, but is not limited to, a structured light sensor, a time-of-flight (ToF) sensor, a binocular stereo vision sensor, a monocular vision sensor, a laser radar, and the like.

The modulation frequency of the depth sensor refers to the frequency of a signal emitted by the depth sensor, e.g., in practical applications, a typical modulation frequency of the time-of-flight sensor may range from 10 MHz to 100 MHz, but the present disclosure is not limited thereto. The exposure time of the depth sensing apparatus is the length of time for an image capturing element of the sensor to receive light. The frame rate of the depth sensing apparatus is the number of image frames that can be captured and output by the sensor per unit of time, usually measured in frames per second (FPS). In the depth sensor, the frame rate determines how quickly the sensor can update depth information of a scene. The frame-rate proportion of the depth sensing apparatus refers to, in a multi-sensor system, the percentage or importance of the frame rates used by different depth sensing apparatuses during data output relative to the total frame rate of the entire system or relative to the frame rates of other sensing apparatuses. Assuming that a multi-sensor system includes a time-of-flight sensor and a structured light sensor, the time-of-flight sensor and the structured light sensor are used interchangeably, the time-of-flight sensor outputs two frames of data per second (i.e., 2 FPS) and the structured light sensor outputs one frame of data per second (i.e., 1 FPS), then the frame-rate proportion of the time-of-flight sensor is 2/(2+1)=66.7%, and the frame-rate proportion of the structured light sensor is 33.3%.

According to one or more embodiments of the present disclosure, by capturing image data of a real environment, displaying an extended reality image generated based on the image data, determining a gaze area of a user on the extended reality image, and adjusting a control parameter of a depth sensing apparatus based on the gaze area, the control parameter of the depth sensing apparatus may be adjusted more accurately according to the personalized needs of the user, and the depth information of the gaze area may be obtained more accurately, which helps to better understand and process the three-dimensional scene.

In some embodiments, S140 further includes determining a gaze object of the user from the extended reality image based on the gaze area; determining depth information of the gaze object; and adjusting the control parameter of the depth sensing apparatus based on the depth information of the gaze area.

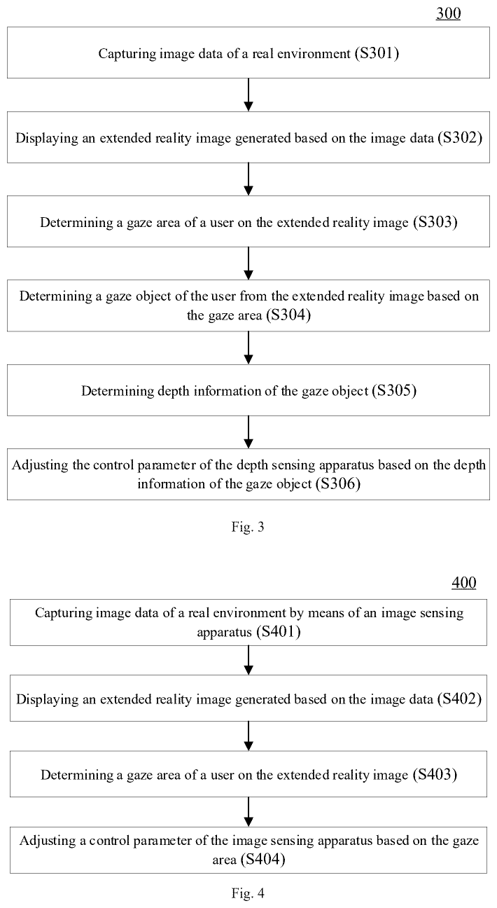

Reference is made to FIG. 3, which shows a schematic flowchart of a method 300 for controlling a sensing apparatus according to an embodiment of the present disclosure. The method 300 includes S301 to S306.
S301: capturing image data of a real environment.
S302: displaying an extended reality image generated based on the image data.
S303: determining a gaze area of a user on the extended reality image.
S304: determining a gaze object of the user from the extended reality image based on the gaze area.
S305: determining depth information of the gaze object.
S306: adjusting the control parameter of the depth sensing apparatus based on the depth information of the gaze object.

In some embodiments, the gaze object corresponding to the gaze area of the user may be determined from the extended reality image through target detection technology. The target detection technology may realize target detection by conventional machine learning, candidate region, deep learning, regression, instance segmentation, transformer, and other techniques, but the present disclosure is not limited herein.

In some embodiments, the depth sensing apparatus may capture depth information of an object in the environment and generates a depth map in which each pixel contains a depth value corresponding to the object in the scene, followed by determining a corresponding position of a pixel of the gaze object in the depth map, thus reading a depth value at that position. In a specific implementation, overall depth information of the gaze object may be obtained based on depth values of all or some of the pixels corresponding to the gaze object. For example, the overall depth information of the gaze object may be obtained based on depth values corresponding to the outer contour pixels of the gaze object, or the overall depth information of the gaze object may be obtained based on depth values of all the pixels corresponding to the gaze object, but the present disclosure is not limited thereto.

In some embodiments, adjusting the control parameter of the depth sensing apparatus based on the depth information of the gaze object includes at least one of the following:
determining a modulation frequency that matches the depth information of the gaze object, and determining a frequency mode used by the depth sensing apparatus based on the modulation frequency that is matched;
determining exposure time of the depth sensing apparatus based on the depth information of the gaze object, where the exposure time has a tendency to decrease as the depth of the gaze object decreases; and
determining, from two or more depth sensing apparatuses, a target depth sensing apparatus adapted to the depth information of the gaze object, and increasing the frame-rate proportion of the target depth sensing apparatus among the two or more depth sensing apparatuses.

In some embodiments, the frequency mode includes at least one of a high-frequency mode, a low-frequency mode, a single-frequency mode, a dual-frequency mode, or a multi-frequency mode. For a depth sensor, different modulation frequencies are adaptable to different depth detection ranges and precisions. The high-frequency mode means that the depth sensing apparatus uses a higher modulation frequency to measure the depth; the low-frequency mode means that the depth sensing apparatus uses a lower modulation frequency to measure the depth; the single-frequency mode means that the depth sensing apparatus uses a single modulation frequency to measure the depth; and the dual-frequency or multi-frequency mode means that the depth sensing apparatus uses more than two different modulation frequencies to measure the depth.

In some embodiments, correlations between different depth detection ranges and different modulation frequencies, different exposure times, or different depth sensing apparatus types may be preset; after the depth information (e.g., the depth value) of the gaze object is determined, the depth detection range to which the depth information of the gaze object belongs may be determined; and based on such correlations, the modulation frequency, exposure time or depth sensing apparatus type associated with such depth detection range may be determined; and then the frequency mode of the depth sensing apparatus is adjusted based on the modulation frequency; alternatively, the determined exposure time is taken as an adjusted exposure time of the depth sensing apparatus; alternatively, a target depth sensing apparatus that is adapted to the depth sensing apparatus type is determined from two or more depth sensing apparatuses integrated on the electronic device, and the frame-rate proportion of the target depth sensing apparatus among the two or more depth sensing apparatuses is increased. Illustratively, for the way of adjusting the frequency mode, the original dual-frequency mode may be adjusted to a single-frequency mode, and the frequency used in the single-frequency mode is adapted to the depth of the gaze object, so that the power consumption of the depth sensing apparatus may be reduced and the depth detection accuracy of the gaze area can be ensured, achieving the optimal power consumption and effect; alternatively, the high-frequency mode and the low-frequency mode are switched from each other, and the switched frequency is adapted to the depth of the gaze object. For the way to increase the frame-rate proportion, the ratio of the frame-rate proportion of the target depth sensing apparatus to that of other depth sensing apparatuses may be adjusted from the original 1:1 to 2:1 or other ratios, and the present disclosure is not limited thereto.

In some embodiments, the depth sensing apparatus includes a direct time-of-flight sensor, and the control parameter includes at least one of a modulation frequency and a frame rate. The direct time-of-flight (dToF) sensor emits a single laser pulse, the time from when light is emitted to when it is reflected back to the sensor is measured directly, and the accurate distance is calculated based on the speed of light. The selection of modulation frequency affects the performance of the direct time-of-flight sensor, including measurement range, accuracy, and resistance to ambient light interference.

In some embodiments, the depth sensing apparatus includes a structured light sensor, and the control parameter includes at least one of exposure time and a frame rate. The structured light sensor refers to a three-dimensional (3D) imaging technique in which known gratings or patterns are projected onto a target object and a camera is used for capturing deformations of these patterns on the surface of the object, where the deformations are caused by the shape and surface properties of the object. By analyzing these deformed patterns, the sensor can calculate the depth information of the object, thus constructing a high-precision 3D model. The exposure time determines the length of time for the sensor to capture light signals of these patterns, which directly affects the quality of the image captured by the sensor and the accuracy of the depth information.

In some embodiments, the depth sensing apparatus includes an indirect time-of-flight sensor, and the control parameter includes at least one of a modulation frequency, exposure time, and a frame rate. The indirect time-of-flight (iToF) sensor is a sensor that calculates the distance by measuring the relative phase difference of a light pulse from the time it is emitted to the time it is reflected by an object and returned to a receiver. The modulation frequency affects the iToF sensor mainly in its balance and optimization of the ranging accuracy, maximum ranging distance, interference immunity, and power consumption. The exposure time affects the amount of light signal received by the iToF sensor, which further affects the ranging accuracy and maximum ranging distance of the sensor.

In some embodiments, determining depth information of the gaze object includes:
acquiring depth data (e.g., the depth map) by the depth sensing apparatus, where the acquiring depth data by the depth sensing apparatus includes at least one of the following:
actively triggering the depth sensing apparatus to acquire depth data in response to determining that the magnitude of change of the gaze object in the extended reality image satisfies a preset first condition; and
reducing the frame rate of the depth sensing apparatus in response to determining that the magnitude of change of the gaze object in the extended reality image satisfies a preset second condition.

In some specific implementations, in response to determining that the magnitude of change (e.g., the magnitude of change in shape, size, or position) in the outer contour of the gaze object in the extended reality image exceeds a preset first threshold (i.e., satisfying the first condition), then the depth sensing apparatus may be actively triggered to capture new depth data; and/or, in response to determining that the magnitude of change (e.g., the magnitude of change in shape, size, or position) in the outer contour of the gaze object in the extended reality image does not exceed a predetermined second threshold (i.e., satisfying the second condition), then the frame rate of the depth sensing apparatus may be reduced. The first threshold or the second threshold may be the same or different, and the present disclosure is not limited thereto.

In some embodiments, the method further includes acquiring running status information of the depth sensing apparatus or an electronic device where the depth sensing apparatus is located, and adjusting the control parameter of the depth sensing apparatus based on the depth information of the gaze object in response to the running status information satisfying a preset condition, where the running status information includes at least one of temperature information, load information, power consumption information, and electricity quantity information.

Illustratively, the temperature of the depth sensing apparatus may be detected by a temperature sensing apparatus that is disposed on or near the depth sensing apparatus; in response to determining that the temperature of the depth sensing apparatus is higher than a preset threshold, the foregoing step of adjusting the control parameter of the depth sensing apparatus based on the depth information of the gaze object may be triggered, e.g., adjusting, by the method of the foregoing one or more embodiments, the depth sensing apparatus from a dual-frequency mode to a single-frequency mode, so that the power consumption of the depth sensing apparatus can be reduced and the accuracy of depth detection of the gaze area can be ensured, achieving the optimal power consumption and effect.

In some embodiments, correlations between different depth information and control parameters (e.g., the modulation frequency, the exposure time, and the frame-rate proportion) of the depth sensing apparatus may be established by a preset model, for adjusting the control strategy of the depth sensing apparatus. Input parameters of the model may include, but are not limited to, a type of depth sensors, depth information of the gaze object, a display mode (e.g., a gaze point mode, and a full field of view mode), information about whether or not to trigger an update of the depth sensing apparatus, information about running status of the depth sensing apparatus or the electronic device where the depth sensing apparatus is located, and the like. Output parameters of the model may include, but are not limited to, the modulation frequency, the exposure time, the frame rate, or the frame-rate proportion, and the like. The present disclosure is not limited thereto.

In some embodiments, the control parameter of the depth sensing apparatus may be dynamically adjusted in real time based on changes in the depth of the gaze area by tracking the gaze area of the user in real time, thus achieving the optimal power consumption and effect.

The inventor has found that the depth sensor control logic provided by related technologies has many problems such as high power consumption, redundant information, or the inability to personalized adjustment, and although some solutions alleviate the problem of high power consumption by reducing the frame rate, this actually reduces the acquisition frequency of the depth sensor, which is prone to information gap. In this regard, according to one or more embodiments of the present disclosure, by adjusting the control parameter of the depth sensing apparatus based on the gaze area of the user on the extended reality image, the depth information of the gaze area may be more accurately obtained, which not only helps to better understand and process the three-dimensional scene, but also ensures the depth detection accuracy of the gaze area while lowering the power consumption of the depth sensing apparatus, thus achieving the optimal power consumption and effect.

Reference is made to FIG. 4, which shows a schematic flowchart of a method 400 for controlling a sensing apparatus according to an embodiment of the present disclosure. The method 400 includes S401 to S404.
S401: capturing image data of a real environment by an image sensing apparatus.
S402: displaying an extended reality image generated based on the image data.
S403: determining a gaze area of a user on the extended reality image.
S404: adjusting a control parameter of the image sensing apparatus based on the gaze area.

In some embodiments, parameters such as a focal length parameter, an exposure parameter, and a white balance parameter of the image sensing apparatus may be adjusted based on the gaze area. In this embodiment, by focusing on the gaze area of the user, the parameter of the image sensing apparatus, such as the focal length, exposure and white balance, may be adjusted more accurately, making the image of the area clearer, more accurate in color, and richer in detail. For example, when the user gazes at a darker corner, the exposure of the area is automatically increased to allow its details to be shown.

In a specific implementation, the focal length parameter of the image sensing apparatus may be adjusted based on position information of the gaze area. For example, the position of the gaze area may be taken as a focal point position to adjust the focal length of the image sensing apparatus, thus achieving the optimal clarity of the gaze area.

In a specific implementation, the exposure parameter of the image sensing apparatus may be adjusted based on brightness information of the gaze area. For example, the exposure parameter (e.g., exposure time, and aperture size) of the image sensing apparatus is adjusted based on a brightness of the gaze area and requirements for exposure to ensure that the brightness of the gaze area is within a suitable range.

In a specific implementation, the white balance parameter of the image sensing apparatus may be adjusted based on color information of the gaze area. For example, the white balance parameter of the image sensing apparatus may be adjusted based on color distribution of the gaze area and requirements for white balance to ensure that the color of the gaze area is true and accurate in presentation.

In some embodiments, the method further includes increasing a weight corresponding to the gaze area in an imaging control algorithm corresponding to the image sensing apparatus. Illustratively, the imaging control algorithm may include, but is not limited to, an Auto Focus (AF) algorithm, an Auto Exposure (AE) algorithm, or an Auto White Balance (AWB) algorithm. Illustratively, the weight corresponding to the gaze area may be increased and the weight of the overall area (e.g., the full field of view) may be decreased in the imaging control algorithm, which may result in a clearer display of the gaze area of the user, thus providing more information about the gaze point of the human eye, and being more targeted.

In some embodiments, by tracking the gaze area of the user in real time, and dynamically adjusting relevant target parameters in the imaging control algorithm based on changes in the position of the gaze area until convergence, it can be ensured that the image captured by the image sensing apparatus presents a natural transition during transformation, avoiding sudden visual changes.

It has been found by the inventors that in a camera system provided by the relevant extended reality device, the imaging control algorithm generally considers information of the entire field of view to make an adjustment, which means that the brightness, color, or depth of field of the entire picture is analyzed. For example, in the automatic exposure algorithm, the system evaluates the brightness distribution within the entire field of view to determine the appropriate exposure setting; and in the automatic focus algorithm, the system may use the contrast information across the entire frame to achieve faster and more accurate focusing. In this regard, according to one or more embodiments of the present disclosure, by adjusting the control parameter of the image sensing apparatus based on the gaze area of the user, the image of the gaze area of the user may be made clearer, more accurate in color, and richer in detail, and the imaging by the image sensing apparatus may be more targeted.

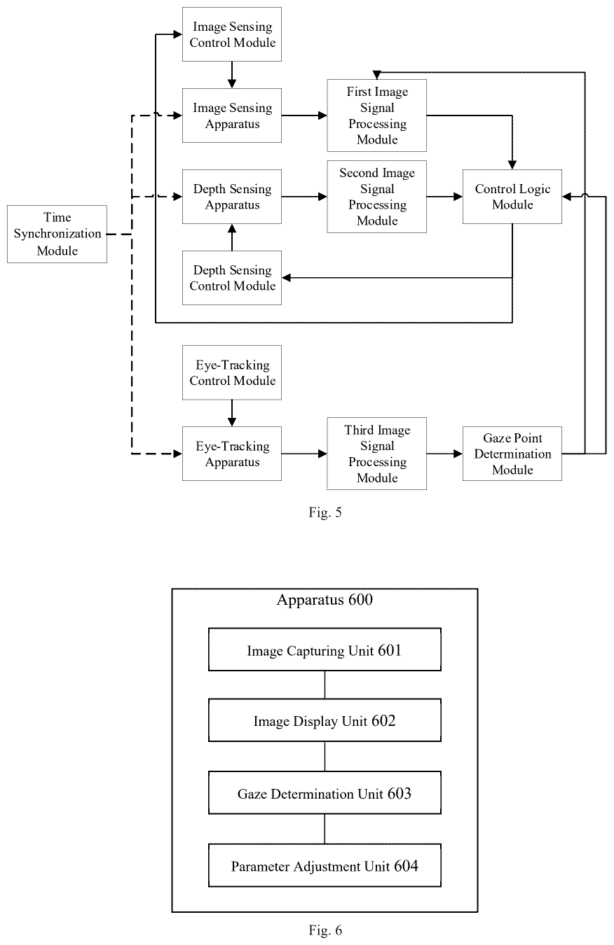

FIG. 5 shows a schematic diagram of a system architecture according to an embodiment of the present disclosure. A time synchronization module may send a synchronization signal to the image sensing apparatus, the depth sensing apparatus, and the eye-tracking apparatus. The signal is intended to accurately calibrate the triggering moments of the respective apparatuses to ensure that the images of the respective apparatuses are temporally aligned so as to achieve a synchronization operation across the apparatuses.

In response to the synchronization signal, the image sensing apparatus, the depth sensing apparatus, and the eye-tracking apparatus capture an environmental image (e.g., an RGB image), an environmental depth image, and a user's eye-tracking image, respectively, and send them to first, second, and third image signal processing modules for processing.

The third image signal processing module may obtain raw data of the eye-tracking image and statistical data thereof based on the received eye-tracking image, and send the data to a gaze point determination module to obtain gaze point information (e.g., the position information of the gaze area) of the user. The gaze point information is sent to the first image signal processing module or a control logic module.

The first image signal processing module may obtain environmental image information and gaze area image information based on the received environmental image and gaze point information, and send the information to the control logic module. The control logic module outputs a control strategy for the image sensing apparatus based on the environmental image information and the gaze area image information to drive an image sensing control module to adjust the control parameter of the image sensing apparatus according to the control strategy. The image information includes, but is not limited to, color information, brightness information, clarity information, and/or statistical information of relevant information of the image.

The second image signal processing module may obtain, based on the received environmental depth image, raw depth information of the environmental depth image and statistical information thereof. The statistical information includes, but is not limited to, a minimum depth, a maximum depth, an average depth, or a standard deviation. The statistical information may help assess the quality of the depth information, such as whether there is an abnormal value, and whether the depth measurement is stable. In some embodiments, the second image signal processing module may also receive the gaze point information and obtain a gaze point depth based on the environmental depth image and the gaze point information.

The control logic module may output the control strategy for the depth sensing apparatus based on the raw depth information, the statistical information of the raw depth information, and the gaze point depth to drive the depth sensing control module to adjust the control parameter of the depth sensing apparatus based on the control strategy.

An eye-tracking control module may control the eye-tracking apparatus based on relevant instructions.

Referring to FIG. 6, provided is an apparatus 600 for controlling a sensing apparatus according to an embodiment of the present disclosure, which includes:
an image capturing unit 601 configured to capture image data of a real environment;
an image display unit 602 configured to display an extended reality image generated based on the image data;
a gaze determination unit 603 configured to determine a gaze area of a user on the extended reality image; and
a parameter adjustment unit 604 configured to adjust a control parameter of a depth sensing apparatus based on the gaze area, where the control parameter includes at least one of a modulation frequency, exposure time, a frame rate, or a frame-rate proportion.

In some embodiments, adjusting a control parameter of a target sensing apparatus based on the gaze area includes determining a gaze object of the user from the extended reality image based on the gaze area; determining depth information of the gaze object; and adjusting the control parameter of the depth sensing apparatus based on the depth information of the gaze object.

In some embodiments, adjusting the control parameter of the depth sensing apparatus based on the depth information of the gaze object includes at least one of the following: determining a modulation frequency that matches the depth information of the gaze object, and determining a frequency mode used by the depth sensing apparatus based on the modulation frequency that is matched, where the frequency mode includes at least one of a high-frequency mode, a low-frequency mode, a single-frequency mode, a dual-frequency mode, or a multi-frequency mode; determining exposure time of the depth sensing apparatus based on the depth information of the gaze object, where the exposure time has a tendency to decrease as the depth of the gaze object decreases; and determining, from two or more depth sensing apparatuses, a target depth sensing apparatus adapted to the depth information of the gaze object, and increasing the frame rate or frame-rate proportion of the target depth sensing apparatus among the two or more depth sensing apparatuses.

In some embodiments, the depth sensing apparatus includes a direct time-of-flight sensor, and the control parameter includes at least one of a modulation frequency and a frame rate.

In some embodiments, the depth sensing apparatus includes a structured light sensor, and the control parameter includes at least one of exposure time and a frame rate.

In some embodiments, the depth sensing apparatus includes an indirect time-of-flight sensor, and the control parameter includes at least one of a modulation frequency, an exposure time, and a frame rate.

In some embodiments, the depth sensing apparatus includes a time-of-flight sensor and a structured light sensor, and the control parameter includes a frame-rate proportion.

In some embodiments, determining depth information of the gaze object includes: acquiring depth data by the depth sensing apparatus, where acquiring depth data by the depth sensing apparatus includes at least one of the following: actively triggering the depth sensing apparatus to acquire the depth data in response to determining that the magnitude of change of the gaze object in the extended reality image satisfies a preset first condition; and reducing the frame rate of the depth sensing apparatus in response to determining that the magnitude of change of the gaze object in the extended reality image satisfies a preset second condition.

In some embodiments, the apparatus further includes:
a status acquisition unit configured to acquire running status information of the depth sensing apparatus or an electronic device where the depth sensing apparatus is located, the running status information including at least one of temperature information, load information, power consumption information, and electricity quantity information.

Adjusting the control parameter of the depth sensing apparatus based on the depth information of the gaze object includes adjusting the control parameter of the depth sensing apparatus based on the depth information of the gaze object in response to the running status information satisfying a preset condition.

In some embodiments, the image capturing unit is configured to capture the image data of the real environment by an image sensing apparatus. The apparatus further includes an image sensing apparatus control unit configured to adjust the control parameter of the image sensing apparatus based on the gaze area, where adjusting the control parameter of the depth sensing apparatus based on the gaze area includes at least one of the following: adjusting a focal length parameter of the image sensing apparatus based on position information of the gaze area; adjusting an exposure parameter of the image sensing apparatus based on brightness information of the gaze area; and adjusting a white balance parameter of the image sensing apparatus based on color information of the gaze area.

In some embodiments, the image sensing apparatus control unit is configured to increase a weight corresponding to the gaze area in an imaging control algorithm corresponding to the image sensing apparatus.

The apparatus embodiment is essentially corresponding to the method embodiment, and therefore, for related information, refer to descriptions of the related parts in the method embodiment. The described apparatus embodiments are merely examples. The modules described as separate modules may or may not be physically separated. Some or all the modules may be selected according to actual needs to achieve the objectives of the solutions of the embodiments. Those of ordinary skill in the art may understand and implement the solutions of the embodiments without creative effort.

Correspondingly, according to one or more embodiments of the present disclosure, an electronic device is provided, which includes:
at least one memory and at least one processor;
where the memory is configured to store program codes, and the processor is configured to execute the program codes stored in the memory to cause the electronic device to perform the method for controlling a sensing apparatus according to one or more embodiments of the present disclosure.

Correspondingly, according to one or more embodiments of the present disclosure, a non-transitory computer storage medium is provided, the non-transitory computer storage medium storing program code, and the program code, upon being executed by a computer device, causing the computer device to perform the method for controlling a sensing apparatus according to one or more embodiments of the present disclosure.

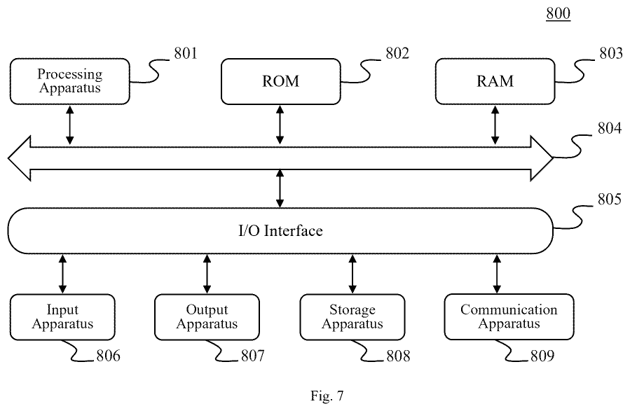

Referring to FIG. 7, FIG. 7 illustrates a schematic structural diagram of an electronic device 800 suitable for implementing some embodiments of the present disclosure. The electronic device illustrated in FIG. 7 is merely an example, and should not pose any limitation to the functions and the range of use of the embodiments of the present disclosure.

As illustrated in FIG. 7, the electronic device 800 may include a processing apparatus 801 (e.g., a central processing unit, a graphics processing unit, etc.), which can perform various suitable actions and processing according to a program stored in a read-only memory (ROM) 802 or a program loaded from a storage apparatus 808 into a random-access memory (RAM) 803. The RAM 803 further stores various programs and data required for operations of the electronic device 800. The processing apparatus 801, the ROM 802, and the RAM 803 are interconnected by means of a bus 804. An input/output (I/O) interface 805 is also connected to the bus 804.

Usually, the following apparatus may be connected to the I/O interface 805: an input apparatus 806 including, for example, a touch screen, a touch pad, a keyboard, a mouse, a camera, a microphone, an accelerometer, a gyroscope, or the like; an output apparatus 807 including, for example, a liquid crystal display (LCD), a loudspeaker, a vibrator, or the like; a storage apparatus 808 including, for example, a magnetic tape, a hard disk, or the like; and a communication apparatus 809. The communication apparatus 809 may allow the electronic device 800 to be in wireless or wired communication with other devices to exchange data. While FIG. 7 illustrates the electronic device 800 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 809 and installed, or may be installed from the storage apparatus 808, or may be installed from the ROM 802. When the computer program is executed by the processing apparatus 801, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to execute the above method of the present disclosure.

The computer program codes for performing the operations of the present disclosure may be written in one or more programming languages or a combination thereof. The above-mentioned programming languages include object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The unit involved in the embodiments of the present disclosure may be implemented in software or hardware. The name of the unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, a method for controlling a sensing apparatus is provided, which includes: capturing image data of a real environment; displaying an extended reality image generated based on the image data; determining a gaze area of a user on the extended reality image; and adjusting a control parameter of a depth sensing apparatus based on the gaze area, where the control parameter includes at least one of a modulation frequency, exposure time, a frame rate, or a frame-rate proportion.

According to one or more embodiments of the present disclosure, adjusting a control parameter of a depth sensing apparatus based on the gaze area includes: determining a gaze object of the user from the extended reality image based on the gaze area; determining depth information of the gaze object; and adjusting the control parameter of the depth sensing apparatus based on the depth information of the gaze object.

According to one or more embodiments of the present disclosure, adjusting the control parameter of the depth sensing apparatus based on the depth information of the gaze object includes at least one of the following: determining a modulation frequency that matches the depth information of the gaze object, and determining a frequency mode used by the depth sensing apparatus based on the modulation frequency that is matched, where the frequency mode includes at least one of a high-frequency mode, a low-frequency mode, a single-frequency mode, a dual-frequency mode, or a multi-frequency mode; determining exposure time of the depth sensing apparatus based on the depth information of the gaze object, where the exposure time has a tendency to decrease as the depth of the gaze object decreases; and determining, from two or more depth sensing apparatuses, a target depth sensing apparatus adapted to the depth information of the gaze object, and increasing a frame rate or a frame-rate proportion of the target depth sensing apparatus among the two or more depth sensing apparatuses.

According to one or more embodiments of the present disclosure, the depth sensing apparatus includes a direct time-of-flight sensor, and the control parameter includes at least one of the modulation frequency and the frame rate.

According to one or more embodiments of the present disclosure, the depth sensing apparatus includes a structured light sensor, and the control parameter includes at least one of the exposure time and the frame rate.

According to one or more embodiments of the present disclosure, the depth sensing apparatus includes an indirect time-of-flight sensor, and the control parameter includes at least one of the modulation frequency, the exposure time, and the frame rate.

According to one or more embodiments of the present disclosure, the depth sensing apparatus includes a time-of-flight sensor and a structured light sensor, and the control parameter includes the frame-rate proportion.

According to one or more embodiments of the present disclosure, determining depth information of the gaze object includes: acquiring depth data by the depth sensing apparatus, where the acquiring depth data by the depth sensing apparatus includes at least one of the followings: actively triggering the depth sensing apparatus to acquire the depth data in response to determining that a magnitude of change of the gaze object in the extended reality image satisfies a preset first condition; and reducing the frame rate of the depth sensing apparatus in response to determining that the magnitude of change of the gaze object in the extended reality image satisfies a preset second condition.

According to one or more embodiments of the present disclosure, the method further includes: acquiring running status information of the depth sensing apparatus or an electronic device where the depth sensing apparatus is located, the running status information including at least one of temperature information, load information, power consumption information, and electricity quantity information; adjusting the control parameter of the depth sensing apparatus based on the depth information of the gaze object includes: adjusting the control parameter of the depth sensing apparatus based on the depth information of the gaze object in response to the running status information satisfying a preset condition.

According to one or more embodiments of the present disclosure, capturing image data of a real environment includes capturing the image data of the real environment by an image sensing apparatus; the method further includes: adjusting a control parameter of the image sensing apparatus based on the gaze area, which includes at least one of the followings: adjusting a focal length parameter of the image sensing apparatus based on position information of the gaze area; adjusting an exposure parameter of the image sensing apparatus based on brightness information of the gaze area; and adjusting a white balance parameter of the image sensing apparatus based on color information of the gaze area.

According to one or more embodiments of the present disclosure, adjusting a control parameter of the image sensing apparatus based on the gaze area includes: increasing a weight corresponding to the gaze area in an imaging control algorithm corresponding to the image sensing apparatus.

According to one or more embodiments of the present disclosure, an apparatus for controlling a sensing apparatus is provided, which includes: an image capturing unit configured to capture image data of a real environment; an image display unit configured to display an extended reality image generated based on the image data; a gaze determination unit configured to determine a gaze area of a user on the extended reality image; and a parameter adjustment unit configured to adjust a control parameter of a depth sensing apparatus based on the gaze area, where the control parameter includes at least one of a modulation frequency, exposure time, a frame rate, or a frame-rate proportion.

According to one or more embodiments of the present disclosure, an electronic device is provided, which includes: at least one memory and at least one processor; where the memory is configured to store program codes, and the processor is configured to execute the program codes stored in the memory to cause the electronic device to perform the method for controlling a sensing apparatus according to one or more embodiments of the present disclosure.

According to one or more embodiments of the present disclosure, a non-transitory computer storage medium is provided, the non-transitory computer storage medium storing program code, and the program code, upon being executed by a computer device, causing the computer device to perform the method for controlling a sensing apparatus according to one or more embodiments of the present disclosure.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A method for controlling a sensing apparatus, comprising:
capturing image data of a real environment;
displaying an extended reality image generated based on the image data;
determining a gaze area of a user on the extended reality image; and
adjusting a control parameter of a depth sensing apparatus based on the gaze area, wherein the control parameter comprises at least one selected from a group of a modulation frequency, exposure time, a frame rate, or a frame-rate proportion.

2. The method of claim 1, wherein the adjusting a control parameter of a depth sensing apparatus based on the gaze area comprises:
determining a gaze object of the user from the extended reality image based on the gaze area;
determining depth information of the gaze object; and
adjusting the control parameter of the depth sensing apparatus based on the depth information of the gaze object.

3. The method of claim 2, wherein the adjusting the control parameter of the depth sensing apparatus based on the depth information of the gaze object comprises at least one selected from a group of:
determining a modulation frequency that matches the depth information of the gaze object, and determining a frequency mode used by the depth sensing apparatus based on the modulation frequency that is matched, wherein the frequency mode comprises at least one selected from a group of a high-frequency mode, a low-frequency mode, a single-frequency mode, a dual-frequency mode, or a multi-frequency mode;
determining exposure time of the depth sensing apparatus based on the depth information of the gaze object, wherein the exposure time has a tendency to decrease as a depth of the gaze object decreases; and
determining, from two or more depth sensing apparatuses, a target depth sensing apparatus adapted to the depth information of the gaze object, and increasing a frame rate or a frame-rate proportion of the target depth sensing apparatus among the two or more depth sensing apparatuses.

4. The method of claim 1, wherein the depth sensing apparatus comprises a direct time-of-flight sensor, and the control parameter comprises at least one selected from a group of the modulation frequency and the frame rate.

5. The method of claim 1, wherein the depth sensing apparatus comprises a structured light sensor, and the control parameter comprises at least one selected from a group of the exposure time and the frame rate.

6. The method of claim 1, wherein the depth sensing apparatus comprises an indirect time-of-flight sensor, and the control parameter comprises at least one selected from a group of the modulation frequency, the exposure time, and the frame rate.

7. The method of claim 1, wherein the depth sensing apparatus comprises a time-of-flight sensor and a structured light sensor, and the control parameter comprises the frame-rate proportion.

8. The method of claim 2, wherein the determining depth information of the gaze object comprises:
acquiring depth data by the depth sensing apparatus, wherein the acquiring depth data by the depth sensing apparatus comprises at least one selected from a group of:
actively triggering the depth sensing apparatus to acquire the depth data in response to determining that a magnitude of change of the gaze object in the extended reality image satisfies a preset first condition; and
reducing the frame rate of the depth sensing apparatus in response to determining that the magnitude of change of the gaze object in the extended reality image satisfies a preset second condition.

9. The method of claim 2, further comprising:
acquiring running status information of the depth sensing apparatus or an electronic device where the depth sensing apparatus is located, the running status information comprising at least one selected from a group of temperature information, load information, power consumption information, and electricity quantity information,
wherein the adjusting the control parameter of the depth sensing apparatus based on the depth information of the gaze object comprises: adjusting the control parameter of the depth sensing apparatus based on the depth information of the gaze object in response to the running status information satisfying a preset condition.

10. The method of claim 1, wherein the capturing image data of a real environment comprises capturing the image data of the real environment by an image sensing apparatus; and
the method further comprises:
adjusting a control parameter of the image sensing apparatus based on the gaze area, which comprises at least one selected from a group of:
adjusting a focal length parameter of the image sensing apparatus based on position information of the gaze area;
adjusting an exposure parameter of the image sensing apparatus based on brightness information of the gaze area; and
adjusting a white balance parameter of the image sensing apparatus based on color information of the gaze area.

11. The method of claim 10, wherein the adjusting a control parameter of the image sensing apparatus based on the gaze area comprises:
increasing a weight corresponding to the gaze area in an imaging control algorithm corresponding to the image sensing apparatus.

12. An electronic device, comprising:
at least one memory and at least one processor;
wherein the memory is configured to store program codes, and the processor is configured to execute the program codes stored in the memory to cause the electronic device to perform a method for controlling a sensing apparatus, and the method comprises:
capturing image data of a real environment;
displaying an extended reality image generated based on the image data;
determining a gaze area of a user on the extended reality image; and
adjusting a control parameter of a depth sensing apparatus based on the gaze area, wherein the control parameter comprises at least one selected from a group of a modulation frequency, exposure time, a frame rate, or a frame-rate proportion.

13. The electronic device of claim 12, wherein the adjusting a control parameter of a depth sensing apparatus based on the gaze area comprises:
determining a gaze object of the user from the extended reality image based on the gaze area;
determining depth information of the gaze object; and
adjusting the control parameter of the depth sensing apparatus based on the depth information of the gaze object.

14. The electronic device of claim 13, wherein the adjusting the control parameter of the depth sensing apparatus based on the depth information of the gaze object comprises at least one selected from a group of:
determining a modulation frequency that matches the depth information of the gaze object, and determining a frequency mode used by the depth sensing apparatus based on the modulation frequency that is matched, wherein the frequency mode comprises at least one selected from a group of a high-frequency mode, a low-frequency mode, a single-frequency mode, a dual-frequency mode, or a multi-frequency mode;
determining exposure time of the depth sensing apparatus based on the depth information of the gaze object, wherein the exposure time has a tendency to decrease as a depth of the gaze object decreases; and
determining, from two or more depth sensing apparatuses, a target depth sensing apparatus adapted to the depth information of the gaze object, and increasing a frame rate or a frame-rate proportion of the target depth sensing apparatus among the two or more depth sensing apparatuses.

15. The electronic device of claim 12, wherein the depth sensing apparatus comprises a direct time-of-flight sensor, and the control parameter comprises at least one selected from a group of the modulation frequency and the frame rate.

16. The electronic device of claim 12, wherein the depth sensing apparatus comprises a structured light sensor, and the control parameter comprises at least one selected from a group of the exposure time and the frame rate.

17. The electronic device of claim 12, wherein the depth sensing apparatus comprises an indirect time-of-flight sensor, and the control parameter comprises at least one selected from a group of the modulation frequency, the exposure time, and the frame rate.

18. The electronic device of claim 12, wherein the depth sensing apparatus comprises a time-of-flight sensor and a structured light sensor, and the control parameter comprises the frame-rate proportion.

19. The electronic device of claim 13, wherein the determining depth information of the gaze object comprises:
acquiring depth data by the depth sensing apparatus, wherein the acquiring depth data by the depth sensing apparatus comprises at least one selected from a group of:
actively triggering the depth sensing apparatus to acquire the depth data in response to determining that a magnitude of change of the gaze object in the extended reality image satisfies a preset first condition; and
reducing the frame rate of the depth sensing apparatus in response to determining that the magnitude of change of the gaze object in the extended reality image satisfies a preset second condition.

20. A non-transitory computer storage medium, wherein the non-transitory computer storage medium storing program code, and the program code, upon being executed by a computer device, causing the computer device to perform a method for controlling a sensing apparatus, and the method comprises:
capturing image data of a real environment;
displaying an extended reality image generated based on the image data;
determining a gaze area of a user on the extended reality image; and
adjusting a control parameter of a depth sensing apparatus based on the gaze area, wherein the control parameter comprises at least one selected from a group of a modulation frequency, exposure time, a frame rate, or a frame-rate proportion.
